(19) United States
(12) Patent Application Publication
(10) Pub. No.: US 2012/0141743 A1
(43) Pub. Date: Jun. 7, 2012

(54) BIOCIDE COATING COMPRISING COPPER

(76) Inventors: Malgorzata-Jadwiga Kolodziej, Wehrheim (DE); Siegbert Strohl, Bad Nauheim (DE); Christian Frontzek, Bad Vilbel (DE); Karlheinz Fitzenberger, Bad Vilbel (DE)

(21) Appl. No.: 13/257,216

(22) PCT Filed: Mar. 16, 2010
(86) PCT No.: PCT/EP2010/001648

§ 371 Date: Dec. 27, 2011

(30) Foreign Application Priority Data
Mar. 16, 2009 (DE) 10 2009 013 029.2

(51) Int. Cl. B32B 3/00

(52) U.S. Cl. 428/189

(57) ABSTRACT

The invention relates to a disinfection element (1, 11, 21) with a copper-based contact region (2, 22), wherein the contact region (2, 22) has a large inner surface in relation to the outer surface (6, 12, 28). Through the use of a disinfection element (1, 11, 21) according to the invention, the antibacterial action of the disinfection element (1, 11, 21) is increased to such an extent that the undesired accumulation of germs and bacteria on contact surfaces can be prevented or at least kept to a minimum in an especially simple manner.

### FIELD OF THE INVENTION

The invention relates to a disinfection element.

In everyday life, people come into contact with bacteria, germs and viruses, often unconsciously. Especially in places where one comes into contact with surfaces that were previously touched by many other people, the mounting accumulation of germs can lead to increasingly unhygienic conditions. Particularly in public institutions and means of transportation, one comes into contact with objects such as, for example, door handles and other contact surfaces on which bacteria can collect and reproduce. Even in institutions that do in fact follow strict hygienic regulations, such as hospitals and kindergartens, pathogens can be transmitted and thus be harmful to health.

### PROBLEM OF THE INVENTION

It is therefore the object of the invention to provide a disinfection element with which such an undesired accumulation of germs can be prevented or at least kept to a minimum in an especially simple manner.

### SOLUTION OF THE PROBLEM

According to the invention, this problem is solved by a disinfection element having a copper-based contact region which has an enlarged inner surface in relation to the outer surface.

Accordingly, the invention comprises a disinfection element with a copper-based contact region, and with the contact region having a large inner surface. As a result thereof, the antibacterial effect of the disinfection element can be increased and the danger of transmission of harmful bacteria and germs reduced.

Since one comes into contact with bacteria and germs in many places in everyday life, in a first step, the invention proceeds from the insight of using a disinfection element with a copper-based contact region. In order to achieve a reduction of the transmission and reproduction of germs and bacteria in contact surfaces accessible in public, such as door handles, light switches or hand rails in buses and trains, copper-based contact surfaces can be used, since copper has a toxic effect on many microorganisms even in small quantities.

In a second step, the invention proceeds from the idea of using a disinfection element with an inner surface that is as large as possible. Through the enlargement of the inner surface, the number of places in which bacteria and germs can be adsorbed or can react, for example, is increased, so that a greater number of bacteria can be killed as the surface increases.

Finally, in a third step, the invention takes advantage of this insight to the effect that, in order to increase the disinfectant action, a disinfection element with a copper-based contact region and a large inner surface is used. Through the combination of the aforementioned features, the effectiveness of a disinfection element can be increased considerably with respect to the disinfectant action, thus reducing the transmission of bacteria.

The disinfectant action of copper, which forms the basis of the contact region, has been known since antiquity. Even then, copper was used for the treatment of eye diseases and in veterinary medicine and later, before the use of modern medications, for the treatment of asthma and pertussis.

Due to this characteristic, it makes sense to use disinfection elements with a copper-based contact region precisely in those places where the transmission of germs and bacteria is high. Accordingly, these disinfection elements can be used particularly in places in which germs and bacteria are able to quickly spread as a result of large quantities of people or the presence of a number of pathogens. Through the use of disinfectant agents, the spread and survival rate of bacteria and germs can be reduced.

Particularly as a result of the resistance of various bacteria to antibiotics and penicillin, for example MRSA (methicillin-resistent Staphylococcus aureus), test series were conducted with different elements made of copper and copper-containing alloys. The results show that the probability of survival of the bacteria decreases as the copper content increases. For example, the bacteria survived for several days on elements made of steel, whereas the survival time dropped sharply down to a few minutes when workpieces made of brass with a high copper content and elements made of pure copper were used. Through the use of elements made of copper, one therefore achieves a reduction of the risk of transmission of pathogens, for example.

In order to increase the effectiveness of the disinfection element yet further beyond the use of a copper-based contact region, the disinfection element according to the invention should have a large inner surface in relation to the outer surface.

The outer surface is the geometric surface directly visible from outside, i.e., the surface that one would get in the process of wrapping the disinfection element.

In contrast to the outer surface, the inner surface comprises the entirety of all surfaces of porous or grainy solids contained in a body. Considered here are both the outer surface and surfaces which arise between the individual grains or as a result of the pore edges within the body and which cannot necessarily be detected when viewed from the outside.

A large inner surface can be achieved either through the structuring of the outer surface, through the increased porosity of a body, or through a combination of increased porosity and an additionally structured surface.

A structure can be applied to the outer surface of a body by means of various chemical or mechanical methods. Due to the enlarged surface and the resulting increasing number of places at which, for example, the bacteria can react and/or be adsorbed, the disinfectant action of the disinfection element can be increased.

Alternatively or in addition, the inner surface of a body can be enlarged even further through the use of a porous body.

Porosity describes the ratio of the void volume to the total volume of a body and is composed of the sum of all voids that are connected to each other and to the outside. Here, both so-called “open” porosity and “closed” porosity must be considered.

Open-pored bodies offer an elevated useful surface for the adsorption of substances, since they are accessible from outside. They are of great interest particularly in catalyst technology. In general, catalysts are used to increase the rate of a reaction without being used up themselves. In engineering, catalysts are used in many applications, particularly in the automobile industry, where they are used for emissions cleaning, for example.

When using an open-pore system, which is to say a catalyst, for example, substances on the surface of another material adsorb or react and accumulate there. A distinction is made here between physical adsorption and chemical adsorption. Physical adsorption can be a reversible process, meaning that the adsorbed substances can desorb again. In contrast, due to the covalent bonds formed, chemical adsorption is irreversible and offers the possibility of tightly bonding the adsorbed molecules to the surface.

If a disinfection element has a contact region with a high degree of porosity or an externally applied structure and consequently has a large inner surface, then the surface has catalytic characteristics. As a result of the bacteria being adsorbed and reacting with the surface of a contact region, they are killed off and lose their harmful effect.

These mechanisms described above also occur on outer surfaces of non-porous bodies, of course, so an outer surface into which a structure is applied in order to increase the inner surface is also available for adsorption and reaction and therefore also has catalytic characteristics.

While bodies with closed porosity—foams, for example—may also have a large inner surface, this surface is not accessible from outside. Such bodies offer the advantage that, as a result of the trapped air in the pores, they are able to fill out a large volume while having the same geometric dimensions and, at the same time, having low density and weight. For this reason, they are particularly well suited to use as insulation and packaging material, and as installation foam for sealing components. Metallic foams additionally exhibit good energy absorption characteristics are suitable, for example, for house wall facings and coatings.

Various methods are used to determine the porosity of a body. One widespread method is BET measurement (after Brunnauer, Emmett and Teller), an analytic method for determining the size of inner surfaces, particularly in porous solids, by means of gas adsorption. The inner surface of a solid is calculated here from the N₂ adsorption isotherm which is observed at the boiling point of liquid nitrogen. By analyzing the adsorption curves relative to each other, one obtains a volume that corresponds to the quantity of nitrogen required for a monomolecular coating. By taking the surface required for a nitrogen molecule into account, the inner surface of the sample can be determined.

Another possibility is so-called mercury porosimetry (also called mercury penetration or mercury intrusion). This technique provides reliable information about the pore volume and the actual density of porous materials independently of the type and shape thereof. The technique is based on the intrusion of the non-wetting liquid mercury into a porous system under applied pressure. Using the pressure, the corresponding pore volume can be calculated, from which the inner surface of a body may in turn be derived.

To enable the comparison of the inner surface of a copper body, for example, to the inner surface of another body, the inner surface is related either to the mass or to the volume of the body. It is then referred to as the mass-based or as volume-based specific surface area. In the first case, the specific surface area indicates what inner surface area a kilogram of a body (m²/kg) possesses, while the second case describes the inner surface of a body per cubic meter (m²/m³).

Overall, larger reactive surfaces of a contact element can be achieved by using a porous material that offers a large inner surface. Moreover, the outer surface of the contact element can be altered through structuring such that the resulting outer surface is several times larger than the geometric surface of the body.

It is expedient for the contact region of the disinfection element to have a thickness of at least 1 μm, particularly 10 μm. These dimensions are particularly favorable, since a certain minimum thickness is required for the adsorption of the bacteria. This minimum thickness depends on the size of the bacteria. To reduce or nearly entirely prevent the harmful effect of the bacteria on the disinfection element, the thickness of the contact region must therefore be selected such that the bacteria have sufficient surface on which to react.

In an advantageous embodiment of the invention, the contact region has a porosity of greater than 20%, particularly greater than 50%. This ensures that the copper-based material has sufficient porosity, so that the inner surface of the contact region accessible to the bacteria is of sufficient size to increase the disinfectant action. Moreover, the porosity is not so pronounced as to weaken the stability of the disinfection element.

Preferably, the contact region of the disinfection element has a structure for the formation of an enlarged outer surface with a depth of at least 3 μm. The selection of the indicated minimum depth ensures, for example, that bacteria such as the Staphylococcus aureus bacterium, with a usual size of about 1 μm, are able to penetrate into the structure and react.

In principle, the structure of a surface can have a different design. Advantageously, the structure of the contact region is embodied as a cross hatch structure. The cross hatch structure is a structure frequently applied to surfaces, since it can be applied, for example, by means of a generally well-known and technically simple-to-manage honing method. In the cross hatch structure, one obtains a surface pattern with closed channels in different directions. The depth of the structure can be influenced through the use of tools, so-called honing stones, thus making it possible to apply the structure at different depths in the surface depending on use. In addition, there is the possibility of applying a structure to the surface using other methods, such as scratching and etching.

In another advantageous embodiment of the invention, the contact region is mounted on a supporting body. The supporting body can have a number of designs. Just like the contact region, it can be porous, but it is just as possible for it to be composed of a self-enclosed or [sic] material. In this case, it is possible to manufacture the disinfection element from a single piece.

The supporting body is expediently manufactured from a plastic and/or a metal. Consequently, it can be used in many areas in which these materials are used. It is also conceivable, however, for a supporting body to be made of another material such as wood or stone.

Preferably, the contact region is applied as a layer to the supporting body. Through the use of a layering method, the contact region is applied as an adhering layer to the surface of the supporting body. The thickness of the layer can vary here and be adapted to the required standards.

In order to achieve a thin layer on the supporting body, this is applied, for example, by means of dispersion coating, the material used in the coating method being finely distributed as a dispersion. The dispersion is atomized by means of pressurized air and sprayed uniformly onto the substrate. The substrate is subsequently heated in a furnace so that a thin layer is formed.

Moreover, the application of the contact region as a layer on the supporting body is achieved using the fluidized bed coating process. During fluidized bed coating, a powder is fluidized in a fluidized bed, and the substrate is wetted with the powder upon dipping of the heated substrate into the fluidized bed. In this way, a thin coating is formed analogously to a dispersion layer.

In an especially advantageous embodiment of the invention, the disinfection element is embodied as a film. This enables a disinfecting film to be provided to already-existing contact regions with which a number of people come into contact.

One application of such a film could be, for example, in public means of transportation or even in public toilets that are used by many people every day and which might transmit germs. In hospitals as well, where strict hygienic regulations are followed, the transmission rate of invisible, harmful pathogens could be stemmed through the use of disinfecting film. In principle, the film can be sized to any desired dimensions; for example, it can be rectangular, square or round. Custom cuts are also conceivable in order to meet special customer needs or a specially required purpose.

The film is expediently provided on at least one side with an adhesive layer. An adhesive layer offers the great advantage, for example, that a film can be applied automatically. The costs of retrofitting can therefore be limited to the extent that it is not necessary to replace existing objects such as door handles and other contact surfaces in public means of transportation or toilet seats. What is more, the costs to private persons can be reduced as well, since self-application is possible by means of an adhesive layer.

For example, the adhesive layer can be executed, on the one hand, as a double-sided adhesive tape, though it is likewise conceivable, on the other hand, that the adhesive must first be applied to the film in order to then be applied, for example, to a light switch.

### BRIEF DESCRIPTION OF THE DRAWING

In the following, sample embodiments of the invention are explained in further detail on the basis of the drawing

FIG. 1 shows a disinfection element in a cutaway view, wherein only the contact region is porous,

FIG. 2 shows a top view of a disinfection element, and

FIG. 3 shows a disinfection element in a cutaway view, wherein both the contact region and the supporting body are porous.

### DETAILED DESCRIPTION OF THE DRAWING

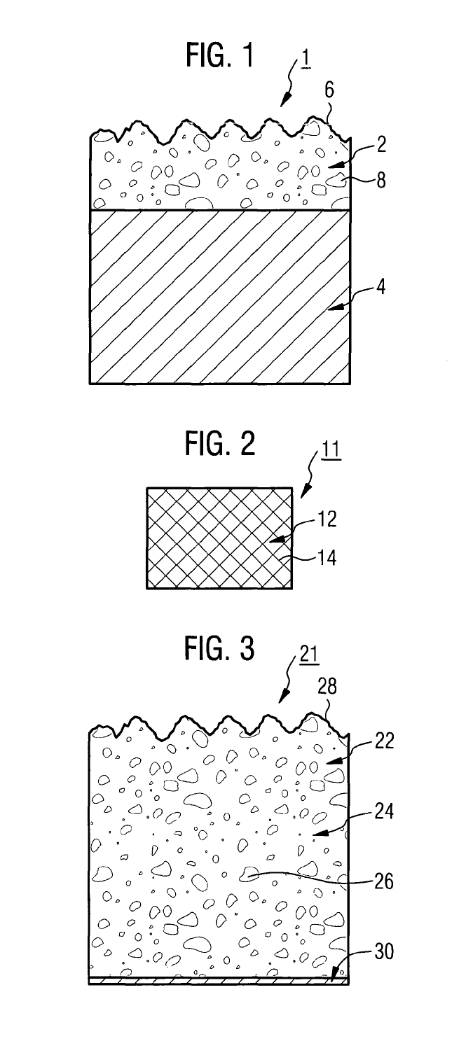

FIG. 1 shows a disinfection element 1 in a cutaway view. The disinfection element 1 is embodied here as a body which is composed of a contact region 2 and a supporting body 4. The contact region 2 is made of copper and applied as a coating on the supporting body 4. The coating is applied by means of the fluidized bed coating method.

The contact region 2 has an outer surface 6 to which a structure is applied. In this case, this structure is applied to the surface using a laser. With the aid of a laser, a cross hatch structure can be applied to the surface, for example. This process involves the use of a laser beam to melt the metallic surface and partially vaporize it in order to form the desired structure. These methods are particularly suited, for example, to small surfaces.

The outer surface 6 offers a multitude of possible adsorption locations for bacteria and germs. In addition, the contact region 2 is highly porous, with pores 8 of different sizes.

As a result of the pores 8, the inner surface, which is to say the entirety of all surfaces contained in the contact region 2, is enlarged. These also include, in addition to the outer surface 6 visible from the outside, all of the surfaces present in the contact region 2 that derive from the edges of the pores 8, for example, and need not necessarily be visible from outside. The contact region 2 therefore offers a large overall inner surface resulting from the sum of the above-mentioned individual surfaces for the adsorption of bacteria and germs and hence for the elevation of the disinfectant action as well.

Like the contact region 2, the supporting body 4 is also made of copper. Unlike the contact region, however, it has no pores but is embodied as a metal lattice. Alternatively, the supporting body 4 can also be manufactured from another metal such as aluminum or steel or from a plastic.

FIG. 2 shows a top view of a disinfection element 11 with a structure 14 applied to the outer surface 12. The structure 14 is embodied as a cross hatch structure. The cross hatch structure 14 is applied to the outer surface in this case by means of a honing method and provides a uniform surface structure with, in this case, channels in different directions arranged in parallel. The structure 14 can be varied through the enlargement or reduction of the individual channels and/or by changing the distance between the channels, hence enabling the adaptation of the size of the outer surface 12 to the desired conditions.

In FIG. 3, another disinfection element 21 is shown in a cutaway view. The entire disinfection element 21 is made here from a single piece. Both the contact region 22 and the supporting body 24 are made of copper and have pores 26, unlike in FIG. 1. By virtue of such an embodiment, the disinfection element 21 has a lower density and, accordingly, a lower total weight.

The disinfection element 21 is embodied in FIG. 3 as a film. The contact region 22 of the disinfection element 21 has, as is the case in Fig. as well, a structured outer surface 28 which is applied using an etching method. The method is particularly well suited to the structuring of the outer surface of small metal parts. An example of etching agents used are acids which alter the material to be etched in a chemical reaction—e.g., which oxidize it.

In addition, an adhesive layer 30 is applied to the supporting body 24. This adhesive layer 30 is embodied as a double-sided adhesive tape. It makes it possible to retroactively apply the disinfection element 21 embodied as a film to objects, for example to contact surfaces such as light switches, door handles or toilet seats. Moreover, because of the easy handling offered by a film provided with an adhesive layer 30, retrofitting or improvement in private homes, for example, can be facilitated and improved considerably.

In addition, it is possible for the contact region 22 and the supporting body 24 to have different porosities as a result, for example, of their having been made of different materials. Alternatively, the material of contact region 22 and supporting body 24 can be the same and the difference in porosity can be brought about by the manufacturing methods of the two components.

As an alternative, the supporting body 24 can also be manufactured from another metal such as aluminum or steel or from a plastic and, depending on the intended use, be either porous or embodied as a metal lattice.

### LIST OF REFERENCE SYMBOLS

1 disinfection element
2 contact region
4 supporting body
6 outer surface
8 pores
11 disinfection element
12 outer surface
14 structure
21 disinfection element
22 contact region
24 supporting body
26 pores
28 outer surface
30 adhesive layer

1. Disinfection element (1, 11, 21), with a copper-based contact region (2, 22) which has an enlarged inner surface in relation to the outer surface (6, 12, 28).

2. Disinfection element (1, 11, 21) as set forth in claim 1, wherein the contact region (2, 22) has a thickness of at least 1 μm, particularly 10 μm.

3. Disinfection element (1, 11, 21) [as set forth in] claim 1 or 2, wherein the contact region (2, 22) has a porosity of greater than 20%, particularly greater than 50%.

4. Disinfection element (1, 11, 21) as set forth in one of the foregoing claims, wherein the contact region (2, 22) has a surface structure (14) with a depth of at least 3 μm.

5. Disinfection element (1, 11, 21) [as set forth in] claim 4, wherein the surface structure (14) of the contact region (2, 22) is embodied as a cross hatch structure.

6. Disinfection element (1, 11, 21) as set forth in one of the foregoing claims, wherein the contact region (2, 22) is mounted on a supporting body (4, 24).

7. Disinfection element (1, 11, 21) as set forth in claim 6, wherein the supporting body (4, 24) is made from a plastic and/or a metal.

8. Disinfection element (1, 11, 21) as set forth in claim 6 or 7, wherein the contact region (2, 22) is applied as a layer on the supporting body (4, 24).

9. Disinfection element (1, 11, 21) as set forth in one of the foregoing claims, which is embodied as a film.

10. Disinfection element (1, 11, 21) as set forth in claim 9, wherein the film is provided on at least one side with an adhesive layer (30).
